(19) United States
(12) Patent Application Publication
(10) Pub. No.: US 2008/0104049 A1
(43) Pub. Date: May 1, 2008

(54) DOCUMENT RANKING UTILIZING PARAMETER VARYING DATA

(75) Inventors: Matthew R. Richardson, Seattle, WA (US); Eric D. Brill, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/552,642

(22) Filed: Oct. 25, 2006

(51) Int. Cl. G06F 17/30

(52) U.S. Cl. 707/5

(57) ABSTRACT

The relevancy of search results are improved by exploiting changes in data related to information access. Parameter varying aspects of parameter varying data associated with document access are leveraged to provide enhanced ranking of document. As an aspect of the parameter varies, a rank can be accomplished, producing multiple ranks for a given set of parameter varying data. Parameters such as time, user preferences, popularity, and/or user demographics and the like can be utilized as parameter varying data. Thus, in general, single or multiple varying aspects of the parameters can be employed to produce a set of ranks comprising one or more rankings of document. This technique can be employed with static rankers, dynamic rankers, and/or ranker training data and the like to produce higher relevancy search results, increasing user satisfaction.

### RELATED APPLICATIONS

This application is related to co-pending and co-assigned U.S. applications entitled “USING POPULARITY DATA FOR RANKING,” client reference MS314180.01, filed on Nov. 3, 2005 and assigned Ser. No. 11/266,026 and is incorporated herein by reference.

### BACKGROUND

Communication networks, such as the Internet, allow users from different locations to access data from anywhere in the world. Because of the vastness of the amount of information, users typically employ search engines to find relevant information. This allows the vast amounts of data to be easily accessible to users in any location by simply entering a search query. Results of the query are then returned to the user in a search result list. Typically, these lists are ranked solely on the search query entered by the user. Most users base their selection of a search engine on speed and relevancy. Thus, search engines strive to return search query results in the fastest manner possible while maintaining high relevancy.

A search request can appear in a variety of formats. The user can use keywords, a phrase, or any combination of words depending on the content they are seeking and the location of the search. Search results are returned according to some correlation between the terms entered by the user and the terms associated with a document, for example. When several documents exist that relate to the same or similar terms, there must be some technique in place to order or prioritize the pages to give the user an idea of which pages are better or perhaps more relevant to the users search. The prioritizing of the search results is generally referred to as ‘ranking’ of the search results.

The ranking of documents can be accomplished after a user has entered search terms. This type of ranking is known as ‘dynamic ranking.’ Dynamic ranking usually yields relevant search results but utilizes precious response time to determine appropriate results. To minimize the response time, ‘static ranking’ can be employed. Static ranking determines probable search results before a user enters a search term. This reduces the response time after entry of a search query. However, some relevancy may be lost due to errors in predicting what results a user might be searching for. Thus, a search engine continuously seeks a balance between responsiveness and relevancy to maintain user satisfaction.

### SUMMARY

Parameter varying aspects of parameter varying data associated with document access are leveraged to provide enhanced ranking of documents. As an aspect of the parameter varies, a rank can be accomplished, producing multiple ranks for a given set of parameter varying data. Parameters such as time, user preferences, popularity, and/or user demographics and the like can be utilized as parameter varying data. Thus, in general, single or multiple varying aspects of the parameters can be employed to produce a set of ranks comprising one or more rankings of documents. By recognizing and employing variances in the data, a search engine can supply a user with more appropriate search results. This technique can be employed with static rankers and/or dynamic rankers to produce higher relevancy search results, increasing user satisfaction. It can also augment training data for rankers to increase their performance.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of a document ranking system in accordance with an aspect of an embodiment.

FIG. 2 is another block diagram of a document ranking system in accordance with an aspect of an embodiment.

FIG. 3 is an illustration of an example incorporation of parameter varying rank utilized in a search engine in accordance with an aspect of an embodiment.

FIG. 4 is a flow diagram of a method of ranking documents in accordance with an aspect of an embodiment.

FIG. 5 is a flow diagram of a method of employing parameter varying ranking to determine static rankings in accordance with an aspect of an embodiment.

FIG. 6 is a flow diagram of a method of employing parameter varying ranking to determine dynamic rankings in accordance with an aspect of an embodiment.

FIG. 7 is a flow diagram of a method of employing parameter varying ranking to augment training data for document ranking in accordance with an aspect of an embodiment.

FIG. 8 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

With the instances provided herein, the relevancy of search results is enhanced by exploiting varying aspects of parameter varying data to improve the ranking process of documents. Data that varies given a certain parameter such as, for example, time, is employed to provide at least one rank result based on, for example, an aspect of time (e.g., seconds, minutes, hour, day, week, month, time of day, etc.). In this manner, sets of ranks can be provided for data splits based on the selected aspect of time intervals. This enables the ranking of the documents to be more relevant based on the chosen aspect such as, for example, time. The sets of ranks can then be utilized by static rankers, dynamic rankers, and/or as training data for rankers and the like to improve their performance. Thus, a user who searches for “croissant ” in the morning hours can be returned search results relating to breakfast foods that employ croissants. Likewise, a user who searches for croissants in evening hours can be provided with search results related to dinner recipes that include croissants. Other parameters can include, but are not limited to, user demographics, user preferences, and/or popularity and the like. In general, parameter varying aspects can be exploited as long as there is parameter varying data that is associated with document access.

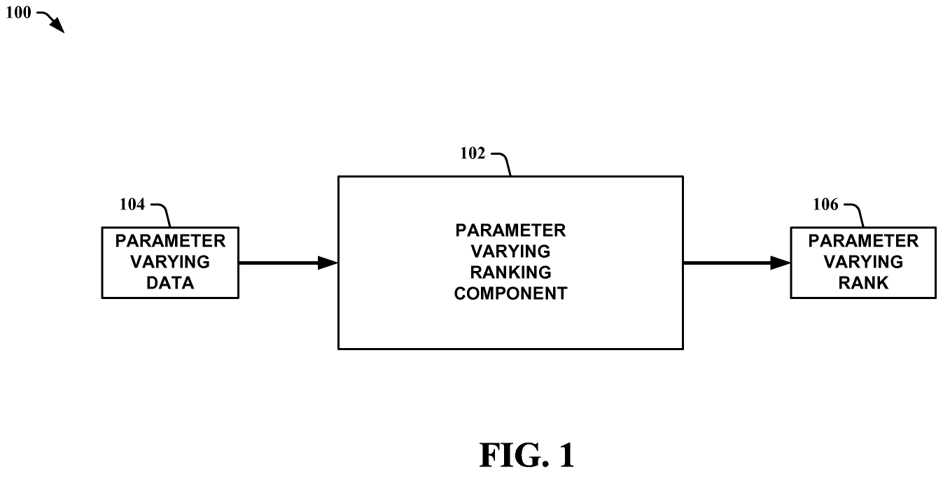

A document ranking system 100 is illustrated in FIG. 1. It utilizes a parameter varying ranking component 102 that obtains parameter varying data 104 and provides parameter varying rank 106. The parameter varying data 104 is generally associated with document access. Thus, data related to users who access online content is commonly employed. Parameters such as, for example, time, user demographics, user preferences, and/or popularity data and the like can be utilized. Aspects of these parameters can be used by the parameter varying ranking component 102 to split the parameter varying data 104 and then each data split can be processed to provide a parameter varying rank 106 for the split. “Documents” can be located, for example, on the Web, on an intranet, and/or on a local computing device and the like. Documents can include, but are not limited to, entities such as HTML, images, videos, papers (PDF, Microsoft Word, etc.), and/or presentations and the like.

Typically, this produces a set of parameter varying ranks that can be employed when a particular parameter varying aspect is exploited to improve search result ranking. Such as with the croissant example given above, for example, a time of day aspect can be utilized to rank croissant related documents differently based on this aspect. Thus, preferred search engine results by users searching for croissants in the morning can influence future searches by users searching croissants in the morning. Similarly, users who reside in New Hampshire and search on “Berlin” may not be seeking information on Berlin, Germany. Thus, demographic information such as, for example, location can be utilized to provide sets of ranks for users based on an aspect of location. Therefore, the New Hampshire user may receive Berlin, N.H. results higher in a provided search result ranking.

Aspects can vary greatly and are not limited by instances provided herein. For example, other aspects of location or geography can include, for example, Midwest, New England, United States, North America, people above a certain elevation, certain latitudes, and/or longitudes and the like. Other demographics that can be utilized include, but are not limited to, age, gender, race, and/or income and the like. In a similar fashion, many aspects of other parameter varying data 104 can be utilized by the parameter varying ranking component 102 to enhance the parameter varying rank 106 for that aspect. It can be appreciated that the instances disclosed herein afford great flexibility in both the type of parameter varying data 104 and/or the aspect that can be leveraged to provide increased ranking performance.

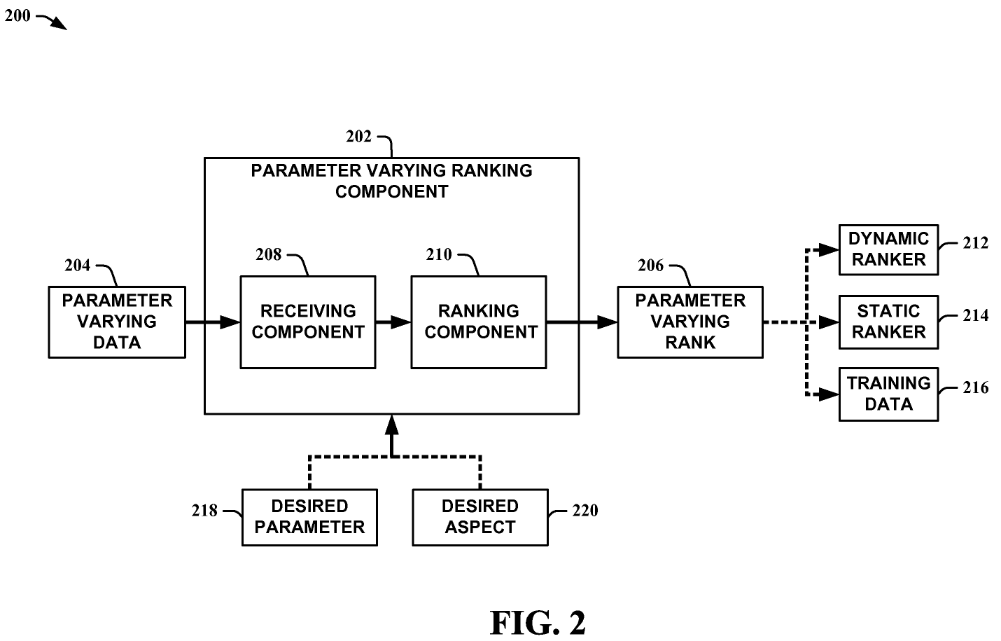

FIG. 2 illustrates a document ranking system 200 that employs a parameter varying ranking component 202 that obtains parameter varying data 204 and provides parameter varying rank 206. The parameter varying ranking component 202 utilizes a receiving component 208 to obtain the parameter varying data 204 and a ranking component 210 to rank the parameter varying data 204 based on a parameter varying aspect. The receiving component 208 can obtain the parameter varying data 204 from a variety of sources but, typically, obtains it from a search engine and the like. The receiving component 208 can also function to sort and/or derive different sets of data from a mixed set of parameter varying data 204. It can also be utilized to process the parameter varying data 204 to determine which parameter is varying within the data 204. It is not uncommon for the parameter varying data 204 to have more than one parameter which varies the data. Thus, the receiving component 208 can facilitate in providing the parameter varying data 204 to the ranking component 210 and/or provide a subset of the parameter varying data 204 based on a desired parameter and the like.

The ranking component 210 processes the parameter varying data 204 and/or a subset based on a data split of a parameter varying aspect. Thus, the ranking component 210 can provide one or more parameter varying rank 206 based on the parameter varying aspect. The parameter varying ranking component 202 can accept optional inputs such as, for example, desired parameter 218 and/or desired aspect 220. This allows a user and/or a system (e.g., search engine, computing platform, etc.) to influence the receiving component 208 and/or the ranking component 210 to provide the parameter varying rank 206 based on the optional inputs 218, 220.

The parameter varying rank 206 provided by the parameter varying ranking component 202 can be utilized, for example, in a dynamic ranker 212, a static ranker 214, and/or training data 216. One can appreciate that output from a static ranker can be utilized in a dynamic ranker and, thus, the parameter varying rank 206 can be utilized directly and/or indirectly by the dynamic ranker 212 (either through direct input and/or indirect input via a static ranker and the like). The training data 216 is typically utilized to train a dynamic and/or static ranker model to enhance its performance. Thus, by utilizing the parameter varying rank 206 in the training data 216, both types of rankers 212, 214 can be improved indirectly via their models.

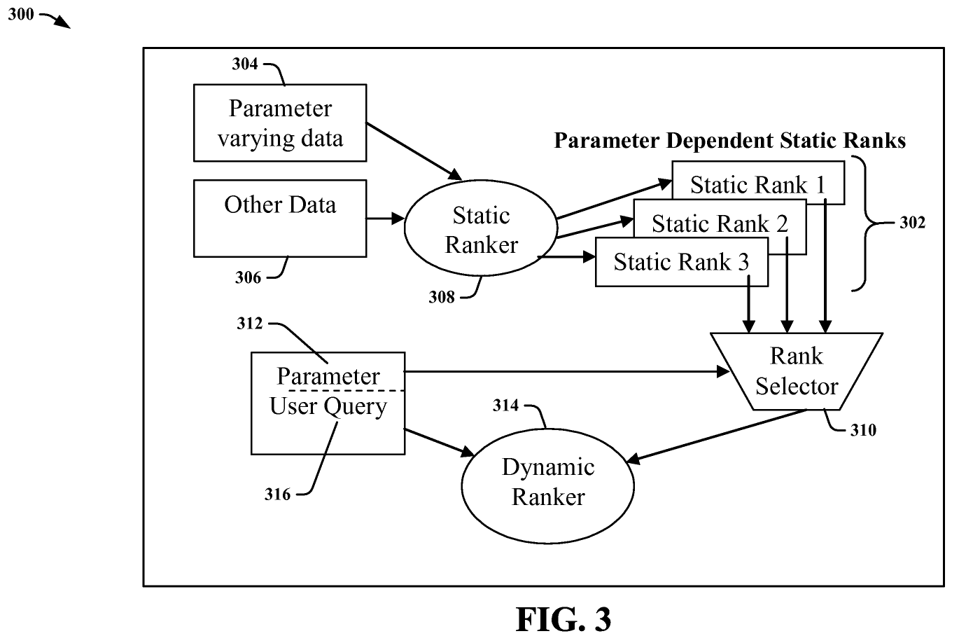

An illustration 300 of an example incorporation of parameter varying rank utilized in a search engine is shown in FIG. 3. This example, for illustrative purposes only, provides multiple static ranks 302 dependent on parameter varying data 304 and, possibly, other data 306. A static ranker 308, in this example, incorporates techniques disclosed herein to provide the multiple static ranks 302 based on the parameter varying data 304. A rank selector 310 then utilizes parameter information 312 to determine which static rank to provide to a dynamic ranker 314 when a user query 316 is provided. This is one of many possible uses of parameter varying rank provided by instances disclosed herein. It can be appreciated that FIG. 3 can be redrawn to incorporate parameter varying data 304 directly into the static ranker 308 and/or the dynamic ranker and the like.

The instances disclosed herein substantially enhance the performance of both static and dynamic rankers. By definition, static ranking refers to ranking documents before the user has submitted a query to the search engine and dynamic ranking refers to ranking after the user has submitted a query. Static ranking of documents is beneficial because it allows selecting of which pages on the web should be in a search engine index, determination of how often to refresh those pages, ordering of the index for good search engine efficiency, and as an input to a dynamic ranker.

Instances herein exploit the fact that the rank of documents can actually vary over time. For example, on the weekends, sites about movies may be more important. In the morning, it may be news sites and in the evening, restaurants, depending on the user's needs, etc., throughout the day. A rank that adjusts to the importance of a page based on, for example, an aspect of, for example, time such as the time of day, day of week, etc. can make a search engine more relevant and/or more efficient. The time varying data can be included directly in a rank computation and/or it can be a summary and/or statistics derived from that data and included in the computation. Thus, this can be accomplished, for example, by using time varying data, particularly user behavior data such as user click-throughs, how often users visit a page, etc., to affect the rank in order to make it vary by time and/or some other parameter.

There are many ways to create a parameter sensitive rank. One way is to utilize user behavior data such as, for example, how many people visit a given page (or set of pages, or domain) in a certain time period (i.e., parameter varying aspect) (e.g., in the morning, or on Monday, etc) to affect the rank. Other data types can be utilizes as well, including popularity data. If the rank directly incorporates popularity data, the time varying nature can be a direct result of filtering the popularity data according to a specified time period (e.g., data from users on Monday) and computing a rank using just that subset of data. In this way, one can immediately compute multiple ranks, each depending on a particular time period.

If the behavior data is not directly used in a rank, it can still be used in a training process. By observing how the behavior data varies across different time sets (like how many people visit a site on Monday vs. any day), the (behavior-less) rank can then be adjusted to have similar qualities. For example, if news sites are viewed much more on Monday than on any other day, then that factor can be added into the rank without actually including the behavior data directly in the rank.

Specifically, a time varying static rank can be used for selecting which documents to crawl, how often to re-crawl those pages, ordering the pages in the index (e.g., for search engine efficiency), and/or as an input to a dynamic ranker and the like. These, except the last, directly affect a search index itself This implies the search engine has multiple indexes, for example,—one for each time period it wants to represent. For example, it can have a weekday morning index, weekday afternoon index, and weekday evening index, and then one more index to cover the entire weekend; any splitting of time (i.e., parameters) is reasonable and the number of splits is typically limited only by the amount of space in memory and/or on disk. By having a time varying static rank (i.e., a parameter varying static rank) as a feature to a dynamic rank, it implies a time varying dynamic rank (i.e., a parameter varying dynamic rank). For example, a time-varying dynamic rank can include, but is not limited to, such things as directly inputting a time of day and/or day of week as features into the dynamic ranker, etc.

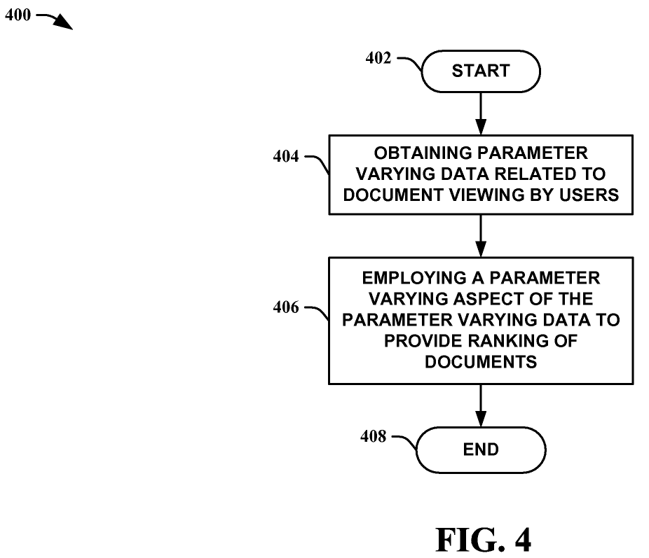

In view of the exemplary systems shown and described above, methodologies that may be implemented in accordance with the embodiments will be better appreciated with reference to the flow charts of FIGS. 4-7. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 4, a flow diagram of a method 400 of ranking documents in accordance with an aspect of an embodiment is shown. The method 400 starts 402 by obtaining parameter varying data related to document viewing by users 404. The parameter varying data can be obtained from a variety of sources but, typically, it is obtained from a search engine and the like. Generally, when users utilize a search engine, the search engine stores parameters related to their searches. A user can also enter in additional information about themselves and/or it can be obtained indirectly through behavior and/or through other means such as “signing on” and/or entering personal information for security purposes and/or to purchase items online and the like. Parameters such as, for example, time, user demographics, user preferences, and/or popularity data and the like can be utilized.

A parameter varying aspect of the parameter varying data is then employed to provide ranking of documents 406, ending the flow 408. Aspects can vary greatly and are not limited by instances provided herein. For example, aspects of location or geography can include, for example, Midwest, New England, United States, North America, people above a certain elevation, certain latitudes, and/or longitudes and the like. Other demographics that can be utilized include, but are not limited to, age, gender, race, and/or income and the like. Typically, this produces a set of parameter varying ranks that can be employed when a particular parameter varying aspect is desired to be exploited to improve search result ranking.

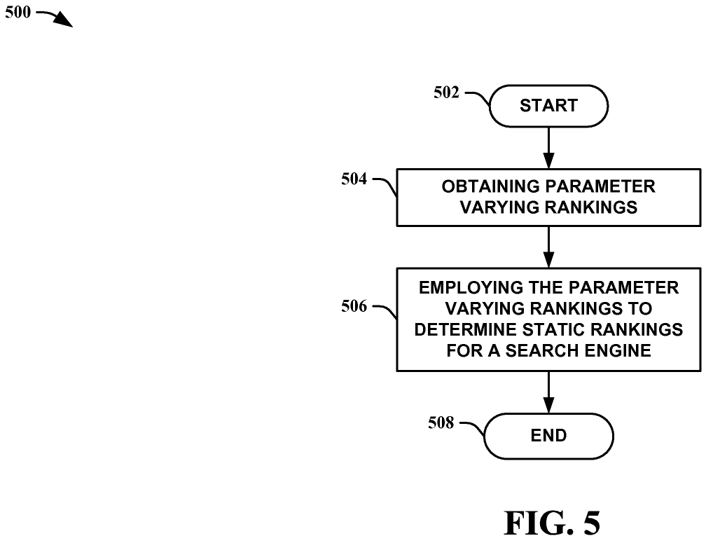

Turning to FIG. 5, a flow diagram of a method 500 of employing parameter varying ranking to determine static rankings in accordance with an aspect of an embodiment is depicted. The method 500 starts 502 by obtaining parameter varying rankings 504. The parameter varying rankings can be obtained from parameter varying rank processes described herein. The parameter varying rankings typically produce a set of multiple ranks that can be utilized based upon a desired parameter varying aspect. The parameter varying rankings are then employed to determine static rankings for a search engine 506, ending the flow 508. Static rankings are rankings that are obtained before a user has entered a search term. Static rankings help to bolster correct indexing and/or help to improve search engine efficiency and the like. By utilizing the parameter varying rankings, the static ranking performance is substantially improved because the static rankings now provide a set of rankings that can be indexed based on a parameter varying aspect. This allows higher relevancy to be obtained while increasing efficiency. Ultimately, higher user satisfaction is also obtained due to the increased relevancy.

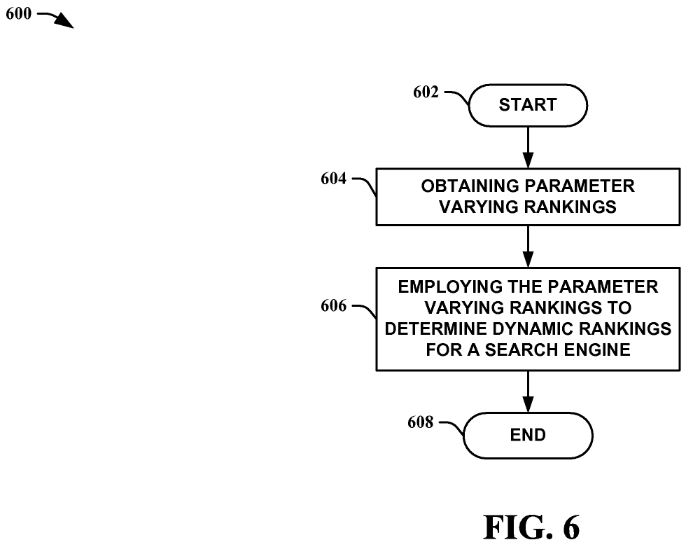

Looking at FIG. 6, a flow diagram of a method 600 of employing parameter varying ranking to determine dynamic rankings in accordance with an aspect of an embodiment is illustrated. The method 600 starts 602 by obtaining parameter varying rankings 604. The parameter varying rankings can be obtained from parameter varying rank processes described herein. The parameter varying rankings typically produce a set of multiple ranks that can be utilized based upon a desired parameter varying aspect. The parameter varying rankings are then employed to determine dynamic rankings for a search engine 606, ending the flow 608. Dynamic rankings are rankings that are obtained after a user has entered a search query. By utilizing the parameter varying rankings, the dynamic ranking performance is substantially improved because the dynamic rankings now have increased relevancy due to their dependency on a parameter varying aspect of a user and/or search query and the like. This allows higher relevancy to be obtained while increasing efficiency (unnecessary searching of non-relevant information is substantially reduced). Ultimately, higher user satisfaction is also obtained due to the increased relevancy provided to the user.

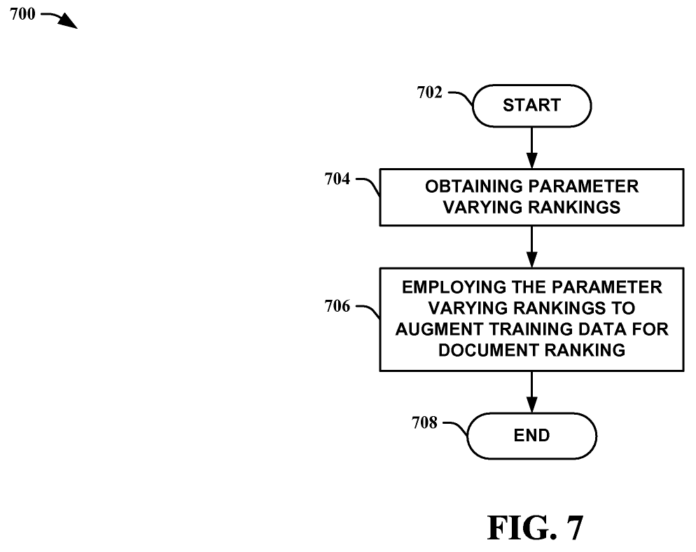

Referring to FIG. 7, a flow diagram of a method 700 of employing parameter varying ranking to augment training data for document ranking in accordance with an aspect of an embodiment is shown. The method 700 starts 702 by obtaining parameter varying rankings 704. The parameter varying rankings can be obtained from parameter varying rank processes described herein. The parameter varying rankings are then employed to augment training data for document ranking 706, ending the flow 708. The training data is typically utilized to train a dynamic and/or static ranker model to enhance its performance. Thus, by utilizing the parameter varying rankings in the training data, both types of rankings can be improved indirectly via their models. For example, even if the parameter varying data is not directly used in a ranking, it can still be used in a training process. By observing how the parameter varying data varies across different parameter varying aspects (like how many people visit a site on Monday vs. any day), the ordinary ranking can then be adjusted to have similar qualities. For example, if news sites are viewed much more on Monday than on any other day, then that factor can be added into the ranking via the training model to impact rankings on Mondays.

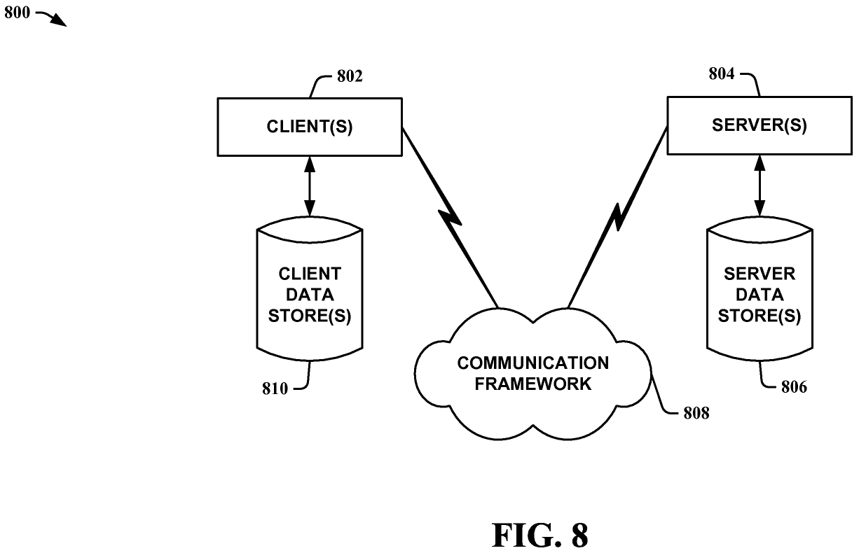

FIG. 8 is a block diagram of a sample system 800 with which embodiments can interact. In general, instances disclosed herein can reside in remote locations and interact via a communication means. The system 800 further illustrates a system that includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). One possible communication between a client 802 and a server 804 can be in the form of a data packet adapted to be transmitted between two or more computer processes. The system 800 includes a communication framework 808 that can be employed to facilitate communications between the client(s) 802 and the server(s) 804. The client(s) 802 are connected to one or more client data store(s) 810 that can be employed to store information local to the client(s) 802. Similarly, the server(s) 804 are connected to one or more server data store(s) 806 that can be employed to store information local to the server(s) 804.

It is to be appreciated that the systems and/or methods of the embodiments can be utilized in document rank facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for ranking documents, comprising:
obtaining parameter varying data related to at least one document; and
employing a parameter varying aspect of the parameter varying data to rank the document.

2. The method of claim 1, wherein the parameter varying data comprises time varying data and the parameter varying aspect comprises a time varying aspect.

3. The method of claim 2 further comprising:
utilizing the time varying data to provide time varying static ranking of documents.

4. The method of claim 1, wherein the parameter varying data comprises user demographic varying data and the parameter varying aspect comprises a demographic varying aspect.

5. The method of claim 1 further comprising:
utilizing the parameter varying data to provide static ranking of documents.

6. The method of claim 5, wherein the parameter varying data comprises individual user varying data and the parameter varying aspect comprises an individual user varying aspect.

7. The method of claim 5 further comprising:
utilizing parameter varying data to construct multiple document ranks.

8. The method of claim 1 further comprising:
utilizing the parameter varying data to provide dynamic ranking of documents.

9. The method of claim 1 further comprising:
incorporating the parameter varying data directly into the ranking of the documents.

10. The method of claim 1 further comprising:
incorporating the parameter varying data into training data utilized for ranking the documents.

11. The method of claim 1, wherein the parameter varying data comprises popularity varying data and the parameter varying aspect comprises a popularity varying aspect.

12. The method of claim 1, wherein the parameter varying data comprises user preference varying data and the parameter varying aspect comprises a user preference varying aspect.

13. A system that ranks documents, comprising:
a receiving component that receives parameter varying data that is associated with a document; and
a ranking component that determines a rank for the document based on, at least in part, a parameter varying aspect of the parameter varying data.

14. The system of claim 13, the parameter varying data comprising user demographic, user preference, popularity, and/or time varying data and associated aspects.

15. A static ranking system that employs, at least in part, the system of claim 13 to determine document ranking.

16. A dynamic ranking system that employs, at least in part, the system of claim 13 to determine document ranking.

17. The system of claim 13, the ranking component provides multiple static rankings based on the parameter varying aspect of the parameter varying data.

18. A system that ranks documents, comprising:
means for obtaining data with a varying aspect that is related to document access by online users; and
means for utilizing the varying aspect in determining a rank for a document employed in a static and/or dynamic search result ranker.

19. A device employing the method of claim 1 comprising at least one selected from the group consisting of a computer, a server, and a handheld electronic device.

20. A device employing the system of claim 13 comprising at least one selected from the group consisting of a computer, a server, and a handheld electronic device.
